(19) United States
(12) Patent Application Publication
(10) Pub. No.: US 2009/0198996 A1
(43) Pub. Date: Aug. 6, 2009

(54) SYSTEM AND METHOD FOR PROVIDING CELLULAR ACCESS POINTS

(75) Inventors: Milton Lie, Plano, TX (US); Brian Forbes, Plano, TX (US); Robert Burke, Dallas, TX (US)

Correspondence Address: FULBRIGHT & JAWORSKI L.L.P, 2200 ROSS AVENUE, SUITE 2800, DALLAS, TX, 75201-2784, US

(73) Assignee: Contineo Systems, Plano, TX (US)

(21) Appl. No.: 12/025,128

(22) Filed: Feb. 4, 2008

(51) Int. Cl. H04L 9/32

(52) U.S. Cl. 713/155

(57) ABSTRACT

A system and method for providing a identity association between a subscriber in a private network and a provider over a public network is described. The system and method include a subscriber security gateway in the private network, the subscriber security gateway providing policy enforcement and signaling between the private network and the provider over the public network and at least one digital key associated with the provider and readable by the subscriber security gateway and operable to provide a identity association with the provider. A network device in the private network, the network device operable to establish a trusted media channel between the provider and the network device using the public network as a result of the signaling and policy enforcement at the subscriber security gateway using the digital keys, and a security gateway in the provider network, the security gateway including a registry for authenticating the user using the digital key and for maintaining a record of the subscriber's relationship with the provider.

### TECHNICAL FIELD

The present invention relates to identity associations in broadband data networks, and more specifically to systems for using identity associations to create secure pathways between end user devices and trusted networks and content providers.

### BACKGROUND OF THE INVENTION

A typical system 100 for proving broadband network access to a home network 109 is shown with regard to FIG. 1. In such a broadband network, a home 101 is usually connected to the broadband network 102 by means of a portal 103, such as a cable modem or a digital subscriber line (DSL) modem. The high speed modem typically has a single internet protocol (IP) address associated with it. The IP address may be fixed or may be dynamically allocated by the internet service provider (ISP). In addition to wireline portals, such as the cable or DSL modems, wireless or cellular portals such as WiMax, or femto or pico cell devices may be used to provide the connectivity between the home 101 and the broadband network 102.

Though there is a single IP address associated with the portal 103, there is often multiple devices connecting to broadband network 102 through portal 103. In such a home network, private addressing schemes are used with network address translation (NAT) provided by the portal or a router connected to the portal. In such a private addressing scheme the portal or router assigns a private address to each device connected to the network and then provides the translation between the private address used on the private side of the portal and the public address used to communicate with broadband network 102. The private addresses are usually dynamically assigned by the portal or router as devices are added and removed from the home network.

Unlike cellular networks, broadband network providers have had difficulty monetizing the use of their network. Customers generally pay a flat fee for unlimited access to the network, and providers have found it difficult to charge premiums for additional services or quality guarantees. The current regulatory system prevents network providers from charging content providers for higher levels of service, absent a specific relationship between the content provider and the customer, and customers have been unwilling to pay premiums. Additionally, topology of home networks, such as the one shown in FIG. 1, make it difficult to establish trusted connections with the end user devices, such as computer 104 or 105, or wireless devices 106, 107 or 108, due to the private addressing scheme used in the home network.

Cellular network providers have had success monetizing their networks by building several features into their networks. Cellular devices use a SIM (Subscriber Identity Module) card, or other similar mechanism for identity association, in each device that provides a secure known identity for each end user device. These SIM cards allow for the cellular network to provide a trusted, or secure association from the device to the network core, also referred to as an explicit path. The trusted connection between end user devices and the core allows for cellular networks to provide direct association between the device and billing systems, ensuring that the premium services used by the device are verified and billed to the correct end user device. This cellular phone example is in contrast to the home network and associated end user devices that have private addresses managed by portal 103. Such private networks and associated devices have no mechanism for establishing secure identity associations. As the portal 103 in the home network is not secured by the network carrier, the portal and the end user devices are outside the secure or trusted border of broadband network 102. The private network and associated devices need a secure connection to the device that allows for the transparent distribution and authentication of security keys.

What is needed is a system that is able to provide a secure, trusted connection between end user devices in a home network and the network carriers core network to allow for billable identity and secure communication with the end user devices.

### BRIEF SUMMARY OF THE INVENTION

In certain embodiments, the present invention is directed to a system and method which provides an identity association between an end user device and a trusted network over a broadband network. An embodiment of a system for providing identity associations includes a device connected to a private network and having access to a public network, the device used to control identity associations for end user devices in the private network. The system also includes multiple digital keys associated with the device, each digital key able to control one or more of identity associations, wherein each identity association allows for one or more derived services, and an authentication mechanism in the trusted to network, the authentication mechanism allowing the derived services between the private network and the trusted network using the device and one or more of the identity associations.

In another embodiment of the present invention, a system for providing an identity association between a subscriber in a private network and a provider over a public network is described that includes a subscriber security gateway in the private network, the subscriber security gateway providing policy enforcement and signaling between the private network and the provider over the public network. The system also includes at least one digital key associated with the provider and readable by the subscriber security gateway and operable to provide a identity association with the provider, and a network device in the private network, the network device operable to establish a trusted media channel between the provider and the network device using the public network as a result of the signaling and policy enforcement at the subscriber security gateway using the digital keys.

In another embodiment of the present invention, a method of establishing an identity association is described which includes providing a control channel between a policy device in a private network and a security gateway in trusted network, using a digital key at the device to authenticate an end user device, and sending content to an end user device separate from the policy device based on the authentication of the end user using the digital key and the device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating an existing home network topology;

FIG. 2 is a block diagram illustrating an embodiment of a system for providing secure, trusted communication between devices in a private network and a core network of a service provider according to the concepts described herein;

FIG. 3 is a block diagram illustrating an alternative embodiment of a system for providing secure, trusted communication between devices in a private network and respective core networks of service providers according to the concepts described herein;

FIG. 4 is a block diagram illustrating an embodiment of a residential gateway according to the concepts described herein;

FIG. 5 is a block diagram illustrating an alternate embodiment of a system for providing secure, trusted communication between devices in a private network and a core network where the system has separate signaling and media channels;

FIG. 6 is a block diagram illustrating an application using the system of FIG. 2, according to the concepts described herein;

FIG. 7 is a block diagram illustrating an embodiment of a process used to create a secure identity associate and billing records between a service provider and end user; and

FIG. 8 is a block diagram illustrating a embodiment of a process for terminating media streams separately from the associated control stream.

### DETAILED DESCRIPTION OF THE INVENTION

In the current state of broadband networks, including the Internet, the network is split into distinct domains which, at the boundaries where they intersect, do include the necessary security protocols to allow simple secure transactions between the domains. For example, a user in a home or small business network may desire to pay for the services or content provided by a third party service provider. In order to get that content, the content must travel from the provider's network over an access network, and possibly a public internet, to a carrier network, and to the user's network and device, again possibly using an access network and a public internet. For a single transaction, the user may be able to establish an account with a user name and password and may provide credit card information to access the content. Unfortunately, since only a user name and password is used these types of transactions are not as secure as could be achieved by using a physical security token by the user. Further these transactions are done on a single transaction basis, where the user must log into their account for every transaction.

What is missing from current broadband networking is a digital supply chain which links the user, carrier and provider. The digital supply chain would use an identity association to provide a secure explicit path through the individual networks (including the provider network, the carrier network, the public network and the user's network) and an authorized relationship and billing agreement between the user and the provider and/or carrier. An identity association, as used herein, refers to a unique token on the user's side of the network and an entry in a provider database corresponding to the token. In the concepts described herein, the token is preferably a physical token such as a smart card or other identifying device issued by a provider that can be used by a user to create an association between the user and the provider. The identity association then allows for derived services between the user and the provider. Such derived services can include allowing the user and provider to establish a security association between the provider's network and the user's device or network. A security association as is understood in the art is a connection between end points that uses security information shared between the end points to support secured communication. The identity association can also be used to allow other derived services, such as establish billing relationships and to enable other services between the user and provider or providing device access or content access in a trusted domain. Using the identity association the digital supply chain can be established allowing carriers and providers to provide such secure content and services to an end user to establish billing arrangements with the user that do not require separate authentication and credit card entry for each transaction.

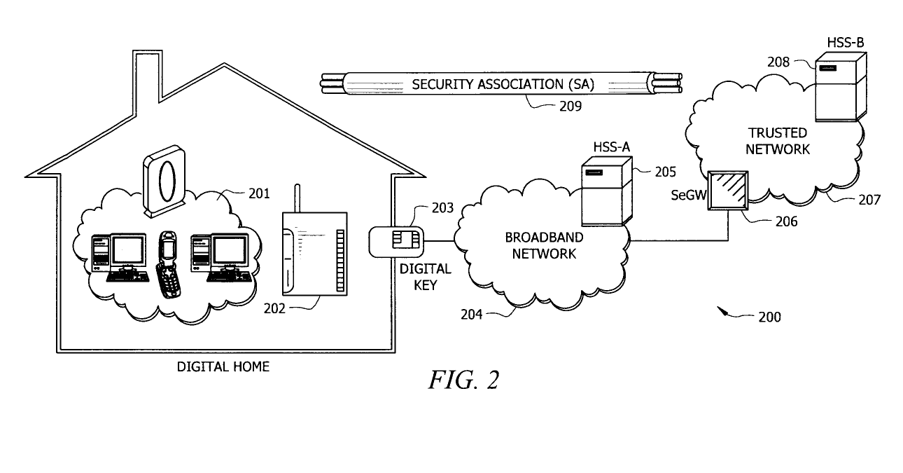

Referring now to FIG. 2, an embodiment of a system 200 for providing secure, trusted access between devices in a private network 201, such as a home network, and a trusted network 207, is shown. Home network 201 uses a private addressing scheme with NAT functionality provided by device 202. Home network may consist of wired network connections, such as Ethernet or cable, wireless networks such as under the IEEE 802.11 scheme, or cellular networks as provided by a cellular femtocell. Other types of networking protocols that use one or more of the previous media are also included in the types of protocols which can be utilized by the concepts described herein. Examples of these other protocols include MoCA (Multimedia over Coax Alliance), HomePNA (Home Phoneline Networking Alliance), VDSL (Very High Speed DSL), or PLC (Power Line Communication).

Device 202 provides the connection between broadband network 204 and home network 201. As described, device 202 provides the NAT functionality to interface between the private network addressing scheme of home network 201 and the public addressing scheme of broadband network 204. Device 202 can also include router and wireless and cellular access point functionality or may be connected to generic base station to provide the access point functionality. According to the concepts described herein, device 202 is also responsible for providing secure access to the home network and authenticating the end user devices in home network 201 as trusted devices.

To accomplish this, device 202 uses digital keys 203 which are incorporated into or are interfaceable with device 202. Digital keys 203 include digital security credentials and may or may not be used in conjunction with user ids and passwords for authentication. The digital keys are incorporated into a digital key interface, which can be a physically connected device which is inserted into a port on device 202, or can be connectionless such as embodiments where the digital key interface is part of an RFID or Smart Card device which is then placed in the proximity of a reader such as device 202. Digital keys 203, by establishing an identity association, may also be used in certain embodiments to implement a security association according to the appropriate standards, such as GAA (Generic Authentication Architecture) 3GPP (Third Generation Partnership Project), or other similar standard. Device 202 and digital keys 203 allow for the encryption of communications to and from device 202 using IPSec or any other appropriate encryption scheme.

Digital keys 203 are, therefore, able to provide an identity association which then allows a secure explicit path, shown by security association (SA) 209, to be created. The digital keys 203 are therefore able to provide the functionality provided by the SIM card in the cellular network context. The digital keys 203 with the device 202 are able to provide a billable identity for the home, or business, or individual user in the home or business that could be used by a device in private network 201 for both communications and content delivery

As described, device 202 provides the interface between private network 201 and broadband network 204. Broadband network 204 includes authentication server 205 which is operable to manage the identity association through broadband network 204. Authentication server 204 can be a home subscriber server which maintains a home location registration that keeps trace of services for each subscriber similarly to the subscriber registry in a cellular network. Broadband network 204 is connected to trusted or provider network 207 through security gateway 206. Security gateway 206 provides secure termination and aggregation for user endpoints that are accessing the trusted core network. Security Gateway provides IPSec Encryption, dynamic session security and real-time bandwidth management to provide security for multiple trusted connections with end user devices such as device 202. Security gateway 206 can be security gateway or session controller as is commonly available. Security gateway 206 provides the termination of security association 209 in the core of trusted network 207. While authentication server 205 provides subscriber services for the broadband network, authentication server 208 provides similar functionality for the provider network 207. Authentication server 208 includes a registry database that keeps track of subscriber identities and allowed services and service and subscriber parameters. The functionality provided by security gateway 206 and/or the authentication server 208 create an authentication mechanism that can be used in conjunction with device 202 and digital keys 203 to establish an identity association. While the authentication mechanism of FIG. 2 has been described with reference to both the security gateway and authentication server, the function of the authentication mechanism could be performed by either one of the devices individually. Further, the security gateway or authentication server could be implemented virtually on one or more devices while still operable functionally to provide the authentication mechanism described herein.

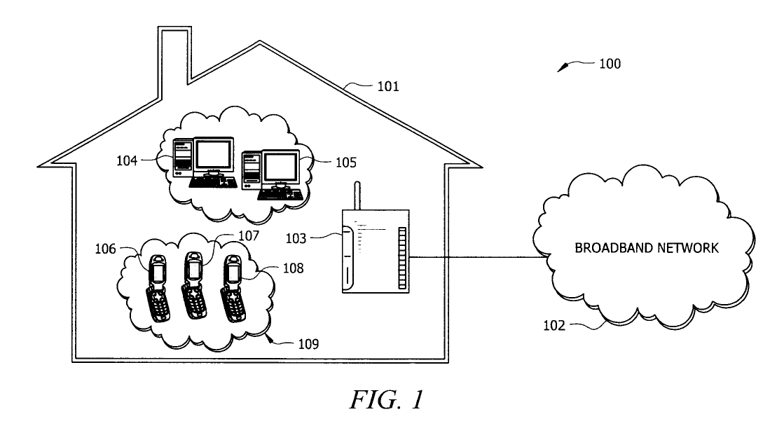

By providing a secure path 209 between private network 201 and trusted network 207, system 200 is able to provide functionality not realizable with the network shown in FIG. 1. System 200, using device 202, digital keys 203 and security gateway 206, is able to provide both secure identity and path between trusted network 207 and private network 201, effectively extending the reach of trusted network 207 to the end user devices in private network 201, and is also able to provide billing identities and relationships not available to traditional broadband network providers.

Different types of functionality are available based on the types of trusted networks connected using the identity association. For example, in embodiments of the system where the trusted network is a content provider, the content provider may be willing to enter into a relationship with a customer to provide content in exchange for the customer receiving advertising from the content provider. In such a case the content provider, based on its relationship with the customer, can enter into an agreement with the provider of the broadband network to provide enhanced services from the content provider to the customer. Based on the billable identity of the customer, the network provider would be able to charge the content provider for the enhanced services, which the content provider would pay for through advertising revenue based on advertising provided to the customer.

In lieu of providing free content to the customer, the content provider may provide pay-per-view or pay-per-use content. In such a case, the customer's billable identity would allow the broadband network provider to bill the customer for the ordered content. The network provider could then keep a percentage of the pay-per-use fees and remit the remaining fee to the content provider. The network provider would be able to leverage its billing relationship with the customer, freeing the content provider from having to bill each end customer.

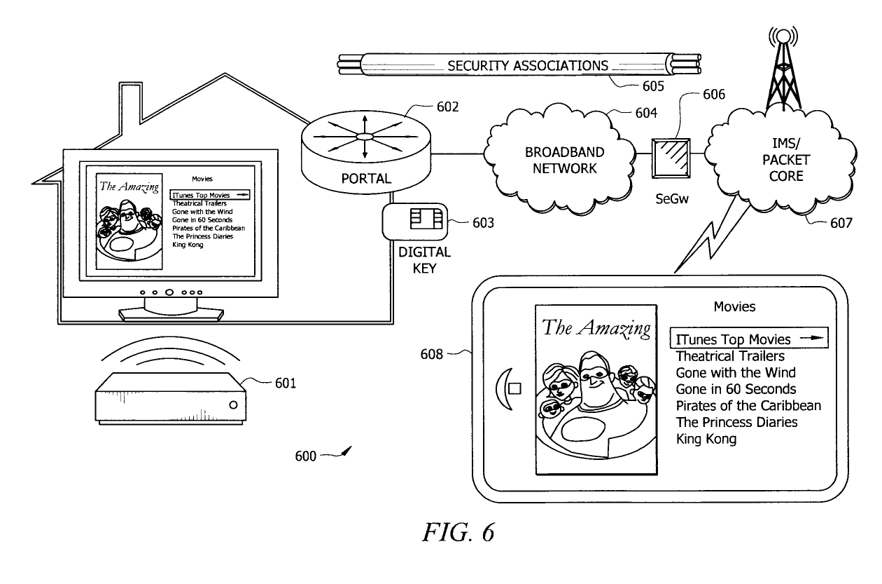

In another embodiment of the system, the identity association would be able to extend the reach of the trusted network to the end user devices. For example, if the trusted network was a wireless provider, the existence of the identity association would allow the mobile customers to access content and devices in the private network from their mobile devices over a secure connection, or could allow data from the private network to be pushed to the mobile device upon the occurrence of a triggering event in the private network. An example of pulling data from private network will be described with reference to FIG. 6. In the case of pushing data from the private network, an event such as the triggering of a security alarm could cause the home network to push data, such as an alert and security camera pictures to the user of a wireless device.

While particular examples have been described to illustrate the types of applications available using a system incorporating the concepts described herein, the examples are not limiting, and any type of functionality or application could be implemented that relies on the identity association, or resulting security association or billable identity or any of the other features described according to the concepts set forth herein.

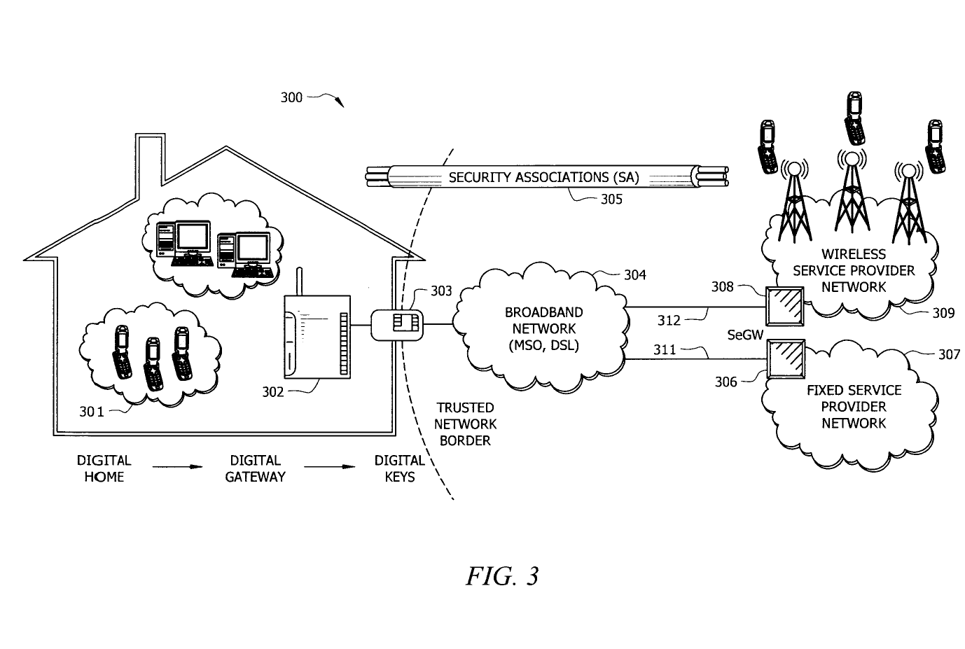

Referring now to FIG. 3, an alternate embodiment of a system 300 incorporating the concepts described herein is shown. Device 302 of system 300 is operable to handle both fixed network communication as well as cellular communications. Device 302 is able to recognize both inbound and outbound fixed network data and cellular network data. Digital keys 303 and device 302 are able to provide secure communications and core functionality to the private network 301 devices. For each identity association for private network devices 301, such as the fixed network identity association and the wireless identity association, a security association, or secure network path is established, as shown collectively by security association 305. Fixed network communications 311 are sent to the fixed service network provider 307 using security gateway 306, while cellular network communications 312 are sent to cellular service network provider 309, both using broadband network 304 and the corresponding security association 305. Device 302 of system 300 includes or is connected to both cellular and data network access points.

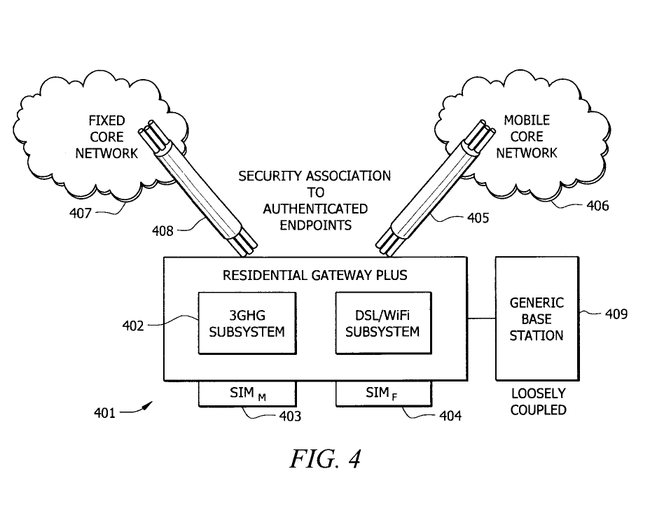

Referring now to FIG. 4, an embodiment of a device/digital key system according to the concepts described herein is shown. Device, 401, which can also be referred to as a residential gateway, includes both a cellular subsystem 402 and a data subsystem 403. Cellular subsystem 402 may incorporate any cellular standard, but preferably includes the functionality of 3G cellular systems. The cellular subsystem 402 includes a femtocell transmitter receiver for communicating with and providing a cellular access point for cellular devices over a very small footprint, such as the area of a residential house. A port 404 provides access to a digital key contained on a digital key interface device, specifically a digital key issued by the cellular carrier and providing a secure link 405 over a broadband network to the cellular carrier's core network 406.

Data subsystem, includes both fixed, such as DSL or cable, and wireless, such as WiFi, connections between device 401 and a fixed core network 407 over secure connection 408. Port 404 allows for a digital key interface device to be connected to device 401 to provide the security associated between device 401 and fixed core network 407. For cellular, wireless, or wireline access remote from device 401 or not included directly within device 401, a generic base station 409 may be provided to provide the access functionality without compromising the security aspects of device 401.

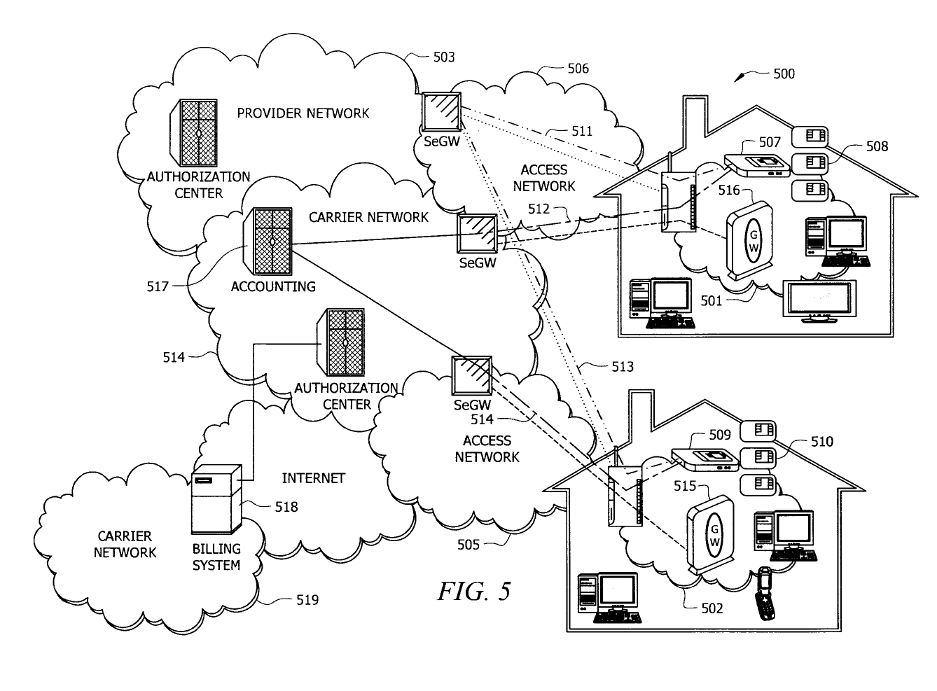

Referring now to FIG. 5, an alternate embodiment of a system 500 for providing secure, trusted access between devices in private networks 501, 502, such as a home network, and a provider network 503 or trusted carrier network 504 using an access network 505 or 506, is shown. System 500 operates similarly to system 200 from FIG. 2 except that the different layers of network traffic (i.e. the signaling layer and the media layer) are each potentially controlled by separate devices. Where a single device, device 202 from FIG. 2, handles both the signaling and media channels, that functionality is distributed over multiple devices in system 500.

Specifically, the policy enforcement and signaling functionality is performed by home security gateway 507, 509. Home security gateway includes the ability to read digital keys 508, 510 used to provide the trusted relationship between the subscriber and the carrier, merchant, or provider of content or services. Using the digital keys, home/subscriber security gateway, 507, 509 is able to create the security associations 511, 512, 513 and 514 which allow for trusted communication between the subscriber and the carrier 503 or provider 504. Unlike system 200 from FIG. 2, however, the services or content can be sent directly to a separate device such as a computer, phone, cellular phone, television, home appliance, or other network enabled device, illustrated in FIG. 5 by devices 515 and 516. This separation allows one device to control all of the policy, signaling information for any number of network enabled devices in the home. In this manner there is a single point of reference for the digital keys and the physical keys do not need to be moved from device to device when used.

The digital keys are preferably physical devices including contactless devices (e.g. smart cards, or devices using RFID type technologies) or contacted devices (e.g. devices inserted into a port on the device). Using a physical device increases the security of a connection by requiring the physical device to be present to establish the connection and is much harder to duplicate or fake than a purely digital security certificate. A home security gateway may have any number of digital keys as required by the subscriber and devices to be used.

Another application of system 200 or system 500, particularly system 500 using home security gateway 507, 509, would be to create secure payment relationships usable by the subscriber. As described, the digital keys can be used to create a billable identity with the subscriber. As such, the home security gateway, as a single point of reference with the digital keys can be turned into a digital wallet to provide secure payment and billing relationships between the subscriber and a carrier, provider or vendor on the network. As the carrier and the subscriber have a trusted relationship with the carrier having a billable identity with the subscriber through the use of the digital keys, the carrier can also act as an intermediary in payment or billing relationships between the subscriber and providers, merchants or vendors. The carrier could use its billing relationship with the subscriber to bill for services, content or items purchased by the subscriber, with the vendors/providers getting a single billing point for many customers. In this manner, vendors/providers can avoid having to establish billing relationships with many individual subscribers. Such billing relationships are illustrated in system 500 by the accounting server 517 in carrier network 504 and billing system 518 in network 519.

Referring now to FIG. 6, an example of an application enabled by the concepts described herein is shown. System 600 allows for the extension of the wireless carrier's trusted network into the private network connected to device 602. Because of the trusted network enabled by device 302 and digital keys 303, mobile device 608 can create a secure connection from the mobile device into the private network and access media server 601. Media server 601 can then be instructed to stream content across the secure connection 605 and back to mobile device 608. Similarly, a device in the private network could be instructed to send data directly to the mobile device over a secure connection upon the occurrence of a particular event. For example, upon the activation of a security alarm the video from a security camera could be sent to a mobile device allowing the user to check the status of the premises remotely.

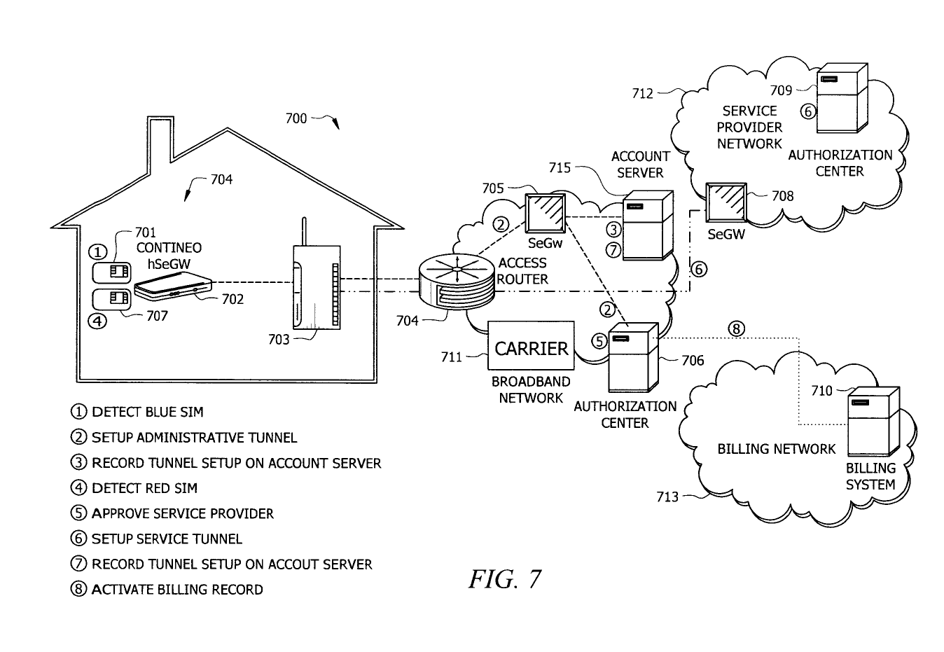

Referring now to FIG. 7, an embodiment of a system 700 for creating and utilizing identity associations is shown. System 700 includes device 702, which accepts digital keys 701 and 707. A portal 703, such as a DSL or cable modem, or other interface device with a public network 711, is used to connect device 702 to carrier access network 711. Service provider network 712 and billing network 713 are also connected with carrier access network 711, though the connection between any of the network shown may utilize a public network.

An embodiment of a process for creating a identity association between the service provider in service provider network 712, and a user in private network 704 using the concepts described herein begins with the detection of digital key 701. Digital key 701 is provided to the end user by the carrier who provides the end user with access to the carrier access network. In this case the carrier access network 711 is the carrier's network and provides the end user with access to the Internet and other networks connected to the carrier's private network. Once digital key 701 has been detected by device 702, device 702 proceeds to make the identity association and then set up a security association, or administrative tunnel, with the carrier using the device 702 and security gateway 705. Authentication server 706 in the carrier's network authenticates the user's identity and privileges using the information on digital key 701, and then records the tunnel setup on account server 715.

Once the identity association and corresponding security association between the carrier and the end user has been established, the end user can then use that security association to establish other identity associations with service providers. Digital key 707 is a digital key issued by the service provider associated with service provider network 712. As described, service provider may be a provider of services, content, goods, etc. Device 702 detects service provider digital key 707, and then sends information associated with that key to the carrier's network to establish the identity association with the service provider using authentication server 706. A security association, or service tunnel, is then set up using security gateway 708 between the device 702 and the service provider network 712. That service tunnel is also recorded on account server 715. Once the service tunnel has been established, a billing record can be activated on billing server 710 in billing network 713 to allow billing of the transaction between the end user and the service provider. The billing system can be part of the carrier or can be part of a third party billing system.

While the process shown in FIG. 7 first requires the setting up of an identity association with the carrier before the identity association is established with the service provider, the system could be set up to allow the end user to establish an identity association directly with the service provider without requiring that the identity association with a carrier having been previously established. Thus, while the digital supply chain may be between the user, carrier and provider, a digital supply chain just between the user and provider is well within the scope of the concepts described herein.

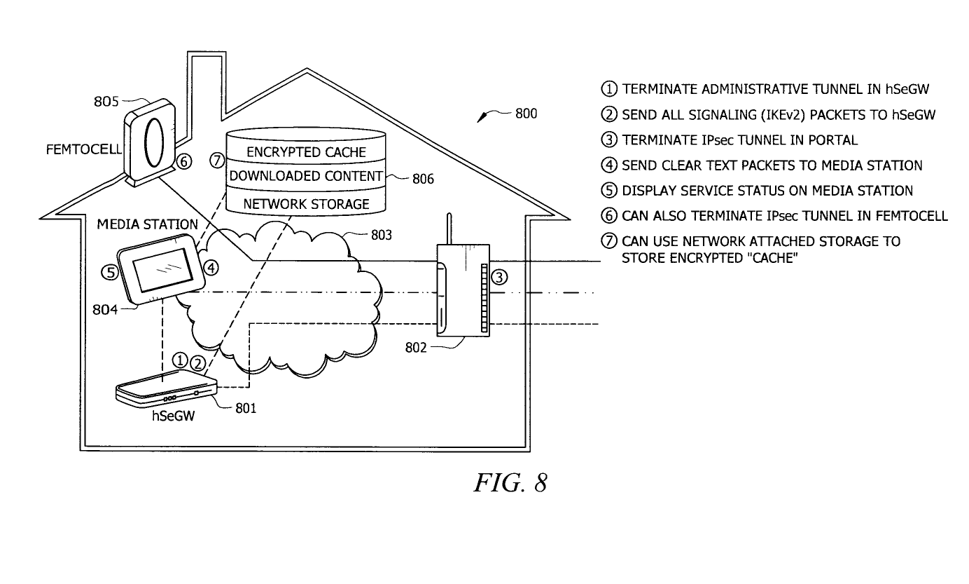

Referring now to FIG. 8, an embodiment of a system 800 which allow for separating the media streams and control streams is described. In system 800 device 801, media station 804 and femtocell 805 are connected to a private network 803 which connects to a public network through portal 802. An administrative tunnel between the private network and the carrier for all the equipment connected to private network 803 is terminated at device 801. Device 801 controls all of the policy enforcement for all of the equipment on private network 803. Once the administrative tunnel is established, all signaling packets entering private network 803 are sent to device 801.

While all signaling packets are sent to device 801, device 801 can instruct portal 802 to direct media packets to another device on private network 803, such as media station 804 or femtocell 805. The separation of signaling or administrative packets from the media or content packets allow device 801 to operate as the policy enforcement point for private network 803. It also allows device 801 to serve as a central point for digital keys which can then be used for services on other equipment connected to private network 803. Thus the policy enforcement, identity and billing functionality can be focused at a single device as opposed to requiring each piece of equipment in the network to have such capability.

In addition, FIG. 8 illustrates another aspect of the concepts described herein. Using the security association, embodiments of system 800 can include storage attached to the private network, as shown by storage device 806. The storage may be any type of storage device, such as network attached storage, internal or external storage associated with a computer or digital video recorder, or any other storage in system 800. Using the security association and billing identities that the identity association allows, providers can pre-place encrypted content onto storage device 806 such that it is immediately available to a user or other device on private network 803. The user, using the billing identity established as a result of the identity association could then agree to pay a fee, or watch advertising, or any other precondition placed by the provider, at which point the provider would send the appropriate keys over the secure connection to decrypt the content for the user. The concepts described herein allow for the pushing of encrypted content into the private network because of its security associations, and can eliminate the need to have such content cached in devices in the network itself, thereby freeing network resources and improving service performance.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a device connected to a private network and having access to a public network, the device used to control identity associations for end user devices in the private network;
multiple digital keys associated with the device, each digital key able to control one or more of identity associations, wherein each identity association allows for one or more derived services; and
an authentication mechanism in the trusted to network, the authentication mechanism allowing the derived services between the private network and the trusted network using the device and one or more of the identity associations.

2. The system of claim 1 wherein the trusted network is controlled by a service provider providing services to the private network.

3. The system of claim 2 wherein service provider is one of a content provider, a service provider, a merchant, a network operator.

4. The system of claim 1 wherein the device is used to terminate a control channel between the private network and the trusted network while an associated bearer channel is terminated at an end user device.

5. The system of claim 1 wherein the derived services include one or more of a security association, a billable identity, device access and content access.

6. The system of claim 2 further comprising storage in the private network, wherein the service provider can pre-place content into the storage for use by end users.

7. The system of claim 2 wherein the authentication mechanism utilizes one or more of a security gateway and an authentication server.

8. A system for providing an identity association between an end user device and a trusted network over a public network, the system comprising:
a device connected to the private network and controlling an administrative channel from the trusted network over the public network;
a digital key associated with the device, the digital key controlling the identity association;
an end user device in the private network, the end user device terminating a bearer channel from the trusted network, the bearer channel associated with the administrative channel.

9. The system of claim 8 wherein the provider is one of a content provider, a service provider, a merchant, a network operator.

10. The system of claim 8 wherein the identity association allows derived services.

11. The system of claim 10 wherein the derived services include one or more of a security association, a billable identity, device access and content access.

12. The system of claim 8 further comprising an authentication mechanism in the trusted network, the authentication mechanism including a registry for authenticating an end user subscriber using the digital key and for maintaining a record of the end user subscriber's relationship with a provider.

13. The system of claim 12 wherein the provider is able to use the digital key to establish a billing identity with the end user subscriber.

14. A method of establishing an identity association comprising:
providing a control channel between a policy device in a private network and a security gateway in trusted network;
using a digital key at the device to authenticate an end user device; and
sending content to an end user device separate from the policy device based on the authentication of the end user using the digital key and the device.

15. The method of claim 14 wherein a provider is able to use the digital key to establish a billing identity with an end user subscriber.

16. The method of claim 15, further comprising pre-placing encrypted content in the private network, the encrypted content purchasable by the end user using a security association established using the digital key.

17. The method of claim 15 wherein the provider is a network carrier.

18. The method of claim 15 wherein the provider is a content provider.

19. The method of claim 15 wherein the provider is a provider of services.

20. The method of claim 15 wherein the provider is a merchant.
